(19) United States
(12) Patent Application Publication
(10) Pub. No.: US 2020/0334344 A1
(43) Pub. Date: Oct. 22, 2020

(54) MODERN AUTHENTICATION

(71) Applicants: Steven R. Schwartz, Fort Lauderdale, FL (US); Juan A. Menadier, Miami, FL (US)

(72) Inventors: Steven R. Schwartz, Fort Lauderdale, FL (US); Juan A. Menadier, Miami, FL (US)

(21) Appl. No.: 16/216,793

(22) Filed: Dec. 11, 2018

(51) Int. Cl. G06F 21/32; H04L 29/06; G07C 9/00; G07C 13/00; G06K 9/00

(52) U.S. Cl. CPC G06F 21/32; H04L 63/102; H04L 63/104; G06K 9/00087; G07C 13/00; G06K 9/00288; G07C 9/00071

(57) ABSTRACT

An advanced authentication system is described herein that applies technology only recently available to areas where the need for security and authentication is growing as well as to traditional areas. The system applies technologies that are substantially unique per individual, such as facial recognition and fingerprint readers. When a user attempts to access a target service secured by the advanced authentication system, the system identifies the user and receives information about the target service the user is trying to access. The system compares the user's identity and authentication information to the known group membership and stored authentication information. If the user is a member of the allowed group to access the target service, then the system allows the user to access the target service. Thus, the system allows people to have confidence in the services they use and can prevent catastrophic events where lax security is a contributing factor.

### BACKGROUND

Security is a common problem and there are many areas of life where security either has been ignored or over time has become less adequate than is prudent for a particular subject area. In many areas of life locks, cameras, and other security measures are commonplace. For example, homes and cars come standard with keyed locks, wireless key fobs, and the like. Other areas of life have less security focused. For example, in many areas voting does not require any more than giving a correct name that is on the voter rolls. Some larger vehicles, such as airplanes, do not have the kind of security that is common in cars, and depend instead on being parked in a secure hanger or other location.

Another aspect of security is authentication, which determines the identity of a particular person and whether that person is authorized to do something. Usernames, possession of a key card, fingerprint scanners, and so forth are all mechanisms for authentication. Many of these forms of authentication can be defrauded to allow someone not authorized to do something, to get away with it anyway. For example, a person who obtains someone else's key card can enter a door secured by a key card reader, even though that person is not the proper owner of the key card. Keys can be possessed by anyone, as can key fobs and usernames. Each year a major data breach is announced where some popular online site leaks the supposedly private usernames and passwords of millions of users.

The last several years have seen many new technologies become available that can be applied to security and authentication. For example, facial recognition, once a fantasy of the movies, is much more readily available today. Fingerprint readers have been placed into mobile smartphones. Even the more connected nature of people through mobile devices is allowing new types of authentication by knowing who is in possession of a device (e.g., two-factor authentication) and where they are.

Many areas that benefit from security and authentication are challenged by the nature of the people who are authorized to enter various areas changing over time. Voter rolls are made inaccurate by a constant inflow and outflow of residents of an area. Corporations' authentication mechanisms must be updated each time an employee is hired or leaves. While some objects, like cars, are made simpler by the fact that there need only be one or two keys to use the car, other objects or privileges are used by larger groups of people, where the membership of the group is regularly changing.

Improper security and authentication can have minor or very grave consequences. In 2018, a man stole a Horizon Air jet plane, did a barrel roll with it over Seattle, and crashed the plane into an island causing an intense fire. Although no one but the pilot was injured, the event highlighted the current state of security for commercial jets. Although the person in that incident was a ground control agent authorized to be on the runway, he was not authorized to pilot the airplanes. Another example is voting. The United States has had many close elections and disputed results in recent years, and allowing any voter fraud, such as allowing an ineligible person to vote, someone to vote as someone they are not, or someone to vote more than once can sway the result of a close election. The temptation for fraud will increase as elections get tighter and the need for demonstrable correctness of the results will be needed to ensure the public's confidence in the fairness of the outcome.

### BRIEF DESCRIPTION OF THE DRAWINGS

FIG. 1 is a block diagram that illustrates components of the advanced authentication system, in one embodiment.

FIG. 2 is a flow diagram that illustrates processing of the advanced authorization system to check for access to a secured service, in one embodiment.

FIG. 3 is a flow diagram that illustrates processing of the advanced authorization system to setup access to a secured service, in one embodiment.

### DETAILED DESCRIPTION

An advanced authentication system is described herein that applies technology only recently available to areas where the need for security and authentication is growing as well as to traditional areas. The system can positively ascertain the identity of a user in a manner that cannot be foiled by loss of an object such as a key, key card, or key fob. The system applies technologies that are substantially unique per individual, such as facial recognition and fingerprint readers. Facial recognition hardware is becoming cheaper and more common, such as the Face ID camera and sensor array employed in recent hardware offerings from Apple, Inc. Previous versions of the same hardware used a Touch ID fingerprint reader. The system also manages membership in a group of users that is properly authorized to perform a target action. Management of group membership involves the system being aware of the identity and unique authentication information (e.g., facial print, fingerprint) of each member of the group, and providing a quick way for a group manager to add and remove members of the group so that the group membership stays up to date as changes occur.

When a user attempts to access a target service secured by the advanced authentication system, the system identifies the user and receives information about the target service the user is trying to access. The system compares the user's identity and authentication information to the known group membership and stored authentication information. If the user is a member of the allowed group to access the target service, then the system allows the user to access the target service. The system may re-authenticate the user periodically and use other secondary mechanisms to verify the user (e.g., two factor authentication), as required in whatever particular circumstance the system is employed.

Although examples are given here for purposes of illustration, the system is not limited to the uses described herein. The system can be applied to buses, airplanes, cars, voting, schools, airports, banks, and any other place where people need to be positively identified and their membership in a group allowed to perform some action needs to be verified.

One example of an area where the advanced authentication system can be employed to achieve better results is commercial aviation. Each airplane of an airline can be equipped with the system and can be managed from a central location to determine group membership for allowed users. For example, each pilot of the airline can have authentication information such as a facial print captured when the pilot obtains a badge or other traditional identification at a central location, such as a security office. A manager of the system, such as security personnel for the airline, can then manage which services of the airline the user is allowed to access. One such service might be piloting airplanes, while another might be accessing a runway. These can be further divided and even managed by time or other factors, such that a particular pilot is only authorized to access select airplanes and even then only for a select duration.

Another example where the advanced authentication system can be productively applied is voter identification and voting. By applying authentication technology that allows a positive determination of a person's identity, and a backend system that allows a positive determination of the proper authority of a particular person to vote in a given jurisdiction, the system can reduce or eliminate voter fraud. The system can be applied to these and many other areas to increase the security of various areas of life. Thus, the system allows people to have more confidence in the services they use and can even prevent catastrophic events where lax security is a contributing factor.

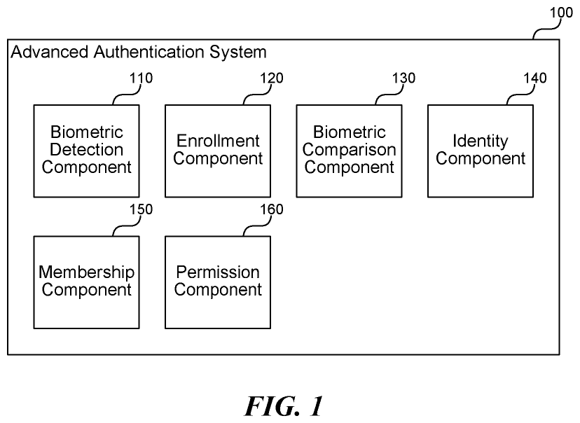

FIG. 1 is a block diagram that illustrates components of the advanced authentication system, in one embodiment. The system 100 includes a biometric detection component 110, an enrollment component 120, a biometric comparison component 130, an identity component 140, a membership component 150, and a permission component 160. Each of these components is described in further detail herein.

The biometric detection component 110 reads a unique characteristic from a requesting person and formats the characteristic as biometric data that is comparable to a database of known biometric data to distinguish the requesting person from other people. The component 110 may include facial recognition hardware, fingerprint reading hardware, a retinal scanner, audio voiceprint detection hardware, or any other type of biometric reading hardware that can observe some characteristic of a person that is different among the substantial majority of people (many biometric methods are known to have exceptions in functionality for people, such as twins, that share a normally unique characteristic among people).

Formatting biometric data may include normalizing the data in some way, so that, for example, even though a person places his or her finger on a fingerprint reader differently each time, the biometric data still matches a known fingerprint of the person. This could include techniques such as selecting a central location of the finger that is commonly on the reader even in multiple positions or placements. Similarly for the face and facial recognition hardware, the biometric data may be normalized to include a limited number of points scanned on the face that stay the same even when the person is wearing, for example, sunglasses or headphones or turns his or her head a different direction.

The enrollment component 120 receives biometric data from people associated with an entity and stores the biometric data in the database for subsequent comparisons of received biometric data to known biometric data to identify someone. The company may have an enrollment procedure during which employees provide their biometric information. For example, when a new employee is hired, he or she may go to a security office of the company to get an ID badge, and at that time the company may ask for a fingerprint, facial scan, or other capture of biometric data with which to populate the database. Likewise, when an employee leaves the company, the company may have a procedure for removing or marking inactive, the biometric data of employees that have departed the company or changed their level of access to what is secured by the system 100.

The biometric comparison component 130 compares the requesting person's read biometric data to the database of biometric data of known persons to identify a matching person in the database. The database may be maintained by a company on a corporate server, such as an airline having a database of biometric data of employees. Following the enrollment procedure, the database is populated with all known persons that would have access to secured services. The comparison may include directly comparing the received biometric data with stored biometric data and looking for an exact match. The comparison may also include a fuzzy match, to which some weighting is applied to determine a match. For example, a received facial scan that matches a stored facial scan by a certain percentage (e.g., 85%), may be declared a match.

The identity component 140 accesses profile information associated with the matching person, which includes one or more security groups to which the matching person belongs. Once a particular person is known, the identity component provides any additional information about that person that is useful for performing security operations. The request may identify a particular security service that the requesting person wants to access, and the system 100 may retrieve from the matching person's profile information about whether that person is authorized to access the particular security service.

The membership component 150 manages one or more security services that people can access, and a list of members with access to each security service. The membership component 150 may provide a function for looking up members of a group as well as a function for looking up the groups of which a person is a member. This allows administrators to manage who is a member of which groups, and thus who can access which security services.

The permission component 160 determines whether the requesting person can access a specific security service to which the requesting person wants access based on the compared biometric data and list of members of the specific security service and either grants or denies access. For example, an airplane cockpit secured with the system 100 using facial recognition may provide a button or other way of invoking the system when a pilot wants to fly the airplane. Facial recognition hardware placed in the airplane then scans the pilot's face and compares the pilots face with a database of facial scans of known pilots to identify the requesting pilot. If the identified pilot is allowed to fly the airplane, then the permission component 160 enables the controls of the airplane to function, else the component 160 denies access to fly the airplane, which may include shutting down the airplane, not allowing the engines to start, or other disabling of the airplane.

The computing device on which the advanced authentication system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, tablet computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

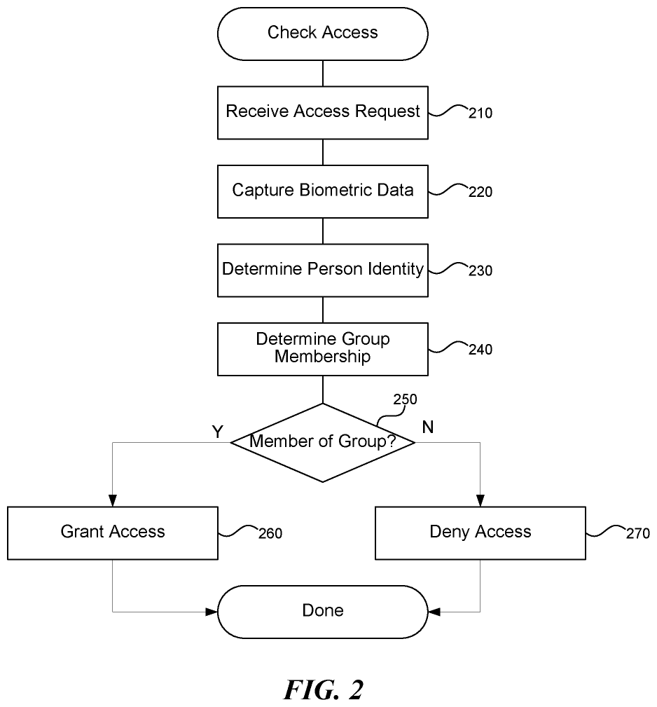

FIG. 2 is a flow diagram that illustrates processing of the advanced authorization system to check for access to a secured service, in one embodiment. Beginning in block 210, the system receives a request to access a secured service. The request may come from a person trying to vote at a voting machine, after pushing a button or otherwise initiating access to the machine. Any activity in life that benefits from certain people being granted access and certain people being denied access can use the system to secure the activity. The system may operate transparently, without users knowing that their access is being verified. For example, a person walking up to a door may activate the system by motion, and the system then scans the user's identity to determine whether to open the door or not.

Continuing in block 220, the system captures biometric data from a requesting person. The biometric data may include fingerprint information, facial scan information, retinal scan information, or any other type of characteristic that is substantially unique to each person. Capturing may occur through specialized hardware dedicated to the system or by common hardware already carried by the person, such as a mobile smartphone with a fingerprint reader.

Continuing in block 230, the system determines the requesting person's identity by comparing the captured biometric data to a database of biometric data of known persons. The system may maintain a profile for each known person that contains all of the information known about that person as well as information about security groups of which the person is a member. Comparing biometric data may include normalizing the captured biometric data to place it in a common format for comparison.

Continuing in block 240, the system determines whether the requesting person is a member of a group of members authorized to access the secured service. The system maintains user groups that identify people authorized to access each secured service recognized by the system. For example, various doors to buildings in a company may be identified as secured services, and each may have a list of members authorized to unlock the door, such as all of the employees with an office in a particular building. Some people, such as an executive, may have access to doors in multiple buildings.

Continuing in decision block 250, if the system determines that the requesting person is a member of the group of members authorized to access the secured service, then the system continues at block 260, else the system continues at block 270.

Continuing in block 260, the system grants the requesting person access to the secured service. Granting access may include unlocking a lock, energizing a relay, allowing access to a secured area of software, or other action to let the requesting person do what is secured by the system. For example, if the secured service is use of the cockpit of an airplane to fly the plane, then granting access may allow the person to start the engines of the plane or disengage the brakes. If the secured service is accessing a building, then granting access may include unlocking a door. If the secured service is voting, then granting access may allow the requesting person to enter a vote.

Continuing in block 270, the system denies the requesting person access to the secured service. Denying access may include not doing the types of things listed in the previous paragraph, but may also include actively doing something to deny the requesting person access, such as locking a door, blocking access to a secured area of software, or disengaging a relay. For example, if the secured service is use of the cockpit of an airplane, then denying access may block access to starting the airplane's engines or disallowing disengaging the airplane's brakes. The system may also notify other people of the denied access, such as security personnel to exclude the unauthorized person from the area. After block 270, these steps conclude.

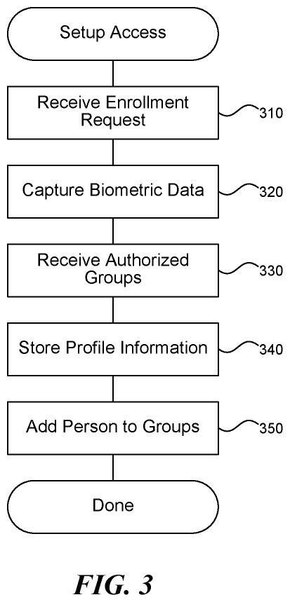

FIG. 3 is a flow diagram that illustrates processing of the advanced authorization system to setup access to a secured service, in one embodiment. Beginning in block 310, the system receives a request to enroll a requesting person in a secured service database. The database may be associated with a company or other entity, and the enrollment process may be part of hiring new employees, or handling promotions or job moves within the company that change an employee's access to services of the company. The enrollment process may be handled by security or other personnel of the company.

Continuing in block 320, the system captures biometric data from a requesting person. The biometric data may include fingerprint information, facial scan information, retinal scan information, or any other type of characteristic that is substantially unique to each person. Capturing may occur through specialized hardware dedicated to the system or by common hardware already carried by the person, such as a mobile smartphone with a fingerprint reader.

Continuing in block 330, the system receives one or more authorized secured services to which the requesting person will be granted access. The system may identify secured services by name, number, or other information. The system may manage a group for each secured service that includes a list of people that are allowed to access the service (whitelist) or a list of people that are not allowed to access the service (blacklist).

Continuing in block 340, the system stores profile information in a profile associated with the requesting person that includes the captured biometric data into the secured service database. The system creates the profile if it is not already in the database or updates the profile if this enrollment represents a change of information for the requesting person. Storing biometric data may include normalizing the biometric data so that minor variations of the biometric data in subsequent captures will match.

Continuing in block 350, the system adds the requesting person to one or more groups associated with the authorized secured services to which the requesting person will be granted access. Each group may list members, other groups, types of users, or other manner of specifying users that can access the secured service(s). The person may also be removed from certain groups for which the person should no longer be a member. After block 350, these steps conclude.

In some embodiments, the advanced authentication system combines multiple types of biometric authentication to create a more secure verification of a requesting person's identity. For example, the system may combine a facial scan and a fingerprint read from the person and only if both match the database of known users, allow the person to access the secured service. The system may also combine with other non-biometric authentication types to increase the security of the system. For example, the system may be combined with two-factor or other additional authentication to further confirm the person's identity.

In some embodiments, the advanced authentication system facilitates upgrading older lock and/or authentication systems with biometric authentication as described herein. Any past system that uses a lock (key or otherwise), door, or other entry mechanism can be upgraded with the advanced authentication system to apply biometric authentication and group membership management to more effectively manage who can access the resources secured by the previous entry mechanism.

From the foregoing, it will be appreciated that specific embodiments of the system have been described herein for purposes of illustration, but that various modifications may be made without deviating from the spirit and scope of the invention. Accordingly, the invention is not limited except as by the appended claims.

1. A computer-implemented method to checking for access to a secured service, the method comprising:
receiving a request to access a secured service;
capturing biometric data from a requesting person;
determining the requesting person's identity by comparing the captured biometric data to a database of biometric data of known persons;
determining whether the requesting person is a member of a group of members authorized to access the secured service and whether a time of receipt of the request is within a select duration during which the requesting person has access;
if the system determines that the requesting person is a member of the group of members authorized to access the secured service based on the captured biometric data and the time of receipt of the request is within the select duration, then granting the requesting person access to the secured service, wherein multiple users having different biometric data can be granted access to the secured service; and
else if the system determines that the requesting person is not a member of the group of members authorized to access the secured service or the time of receipt of the request is not within the select duration, then denying the requesting person access to the secured service,
wherein the preceding steps are performed by at least one processor.

2. The method of claim 1 wherein receiving the request comprises receiving the request from a person trying to vote at a voting machine.

3. The method of claim 1 wherein receiving the request comprises receiving the request from a pilot trying to access the cockpit of an airplane to fly the airplane.

4. The method of claim 1 wherein receiving the request comprises operating transparently, without users knowing that their access is being verified.

5. The method of claim 1 wherein capturing biometric data comprises performing a facial scan.

6. The method of claim 1 wherein capturing biometric data comprises capturing a fingerprint.

7. The method of claim 1 wherein determining the identity comprises maintaining a profile for each known person that contains all of the information known about that person as well as information about security groups of which the person is a member.

8. The method of claim 1 wherein comparing biometric data comprises normalizing the captured biometric data to place it in a common format for comparison.

9. The method of claim 1 wherein determining whether the person is a member of the group comprises maintaining user groups that identify people authorized to access each secured service recognized.

10. The method of claim 1 wherein granting access comprises at least one of unlocking a lock, energizing a relay, or allowing access to a secured area of software.

11. The method of claim 1 wherein granting access comprises when the secured service is use of a cockpit of an airplane to fly the airplane, then granting access allows the person to start the engines of the airplane and disengage brakes.

12. The method of claim 1 wherein denying access comprises actively denying the requesting person access by at least one of locking a door, blocking access to a secured area of software, or disengaging a relay.

13. A computer system for providing an advanced authentication system that secures access to a secured service with biometric data and group membership, the system comprising:
a processor and memory configured to execute software instructions embodied within the following components;
a biometric detection component that reads a unique characteristic from a requesting person and formats the characteristic as biometric data that is comparable to a database of known biometric data to distinguish the requesting person from other people;
an enrollment component that receives biometric data from people associated with an entity and stores the biometric data in the database for subsequent comparisons of received biometric data to known biometric data to identify someone;
a biometric comparison component that compares the requesting person's read biometric data to the database of biometric data of known persons to identify a matching person in the database;
an identity component that accesses profile information associated with the matching person, which includes one or more security groups to which the matching person belongs;
a membership component that manages one or more security services that people can access, and a list of members with access to each security service; and
a permission component that determines whether the requesting person can access a specific security service to which the requesting person wants access based on 1) the compared biometric data, 2) whether a time of receipt of a request is within a select duration during which the requesting person has access, and 3) list of members of the specific security service and either grants or denies access, wherein multiple users having different biometric data can be granted access to the specific security service.

14. The system of claim 13 wherein the biometric detection component includes at least one of facial recognition hardware, fingerprint reading hardware, a retinal scanner, and audio voiceprint detection hardware.

15. The system of claim 13 wherein the biometric detection component normalizes facial recognition data to include a limited number of points scanned on a face that stay the same even when the person turns his or her head a different direction.

16. The system of claim 13 wherein the enrollment component is updated when a new person joins the entity or when an existing person leaves the entity.

17. The system of claim 13 wherein the biometric comparison component uses a database maintained by a company on a corporate server, and wherein following an enrollment procedure, the database is populated with all known persons that would have access to secured services at the company.

18. The system of claim 13 wherein the biometric comparison component applies a fuzzy match, to which a weighting is applied to determine a match.

19. The system of claim 13 wherein the identity component retrieves from the matching person's profile information about whether that person is authorized to access the specific security service.

20. A non-transitory computer-readable medium comprising instructions for controlling a computer system to setup access to a secured service, wherein the instructions, upon execution, cause a processor to perform actions comprising:
receiving a request to enroll a requesting person in a secured service database;
capturing biometric data from the requesting person, wherein the biometric data includes a characteristic that is substantially unique to each person;
receiving one or more authorized secured services to which the requesting person will be granted access and a select duration during which the requesting person has access, wherein multiple users having different biometric data can be granted access to a specific secured service;
storing profile information into the secured service database in a profile associated with the requesting person that includes the captured biometric data; and
adding the requesting person to one or more groups associated with the authorized secured services to which the requesting person will be granted access.
